(19) United States
(12) Patent Application Publication
(10) Pub. No.: US 2014/0310124 A1
(43) Pub. Date: Oct. 16, 2014

(54) VEHICLE DATABASE SYSTEM AND RELATED METHODS

(71) Applicant: Work Truck Solution, Chico, CA (US)

(72) Inventor: KATHRYN SCHIFFERLE, Chico, CA (US)

(73) Assignee: Work Truck Solution, Chico, CA (US)

(21) Appl. No.: 14/250,526

(22) Filed: Apr. 11, 2014

Related U.S. Application Data
(60) Provisional application No. 61/812,712, filed on Apr. 16, 2013.

(51) Int. Cl. G06Q 30/06

(52) U.S. Cl. CPC G06Q 30/0621; G06Q 30/0623
USPC 705/26.5; 705/26.61

(57) ABSTRACT

An online trading system for conducting trade of commercial vehicles at a dealership is disclosed. The online trading system comprises an online trading website and a vehicle database built into the website hosted on a server and managed by a commercial vehicle manager at the dealership. The vehicle database is configured to store virtual inventory including a vehicle body data and a vehicle chassis data of vehicles. The website includes an available vehicle combinations list which includes a list of all possible combinations of vehicle by using data about all available chassis types and combining this with available body models that fit each chassis. The vehicle database allows the dealership, at least one dealer, at least one buyer, a body manufacturer or distributor to access the data of the commercial vehicles via a network so as to conduct trade in a simple and efficient manner.

### RELATED APPLICATIONS

This application is a Nonprovisional Application of and claims priority to U.S. Provisional Patent Application 61/812,712, filed Apr. 16, 2013, which is incorporated herein in its entirety as if set out in full.

### BACKGROUND OF THE DISCLOSURE

1. Technical Field of the Disclosure

The present embodiment relates in general to systems and methods for conducting trade of commercial vehicles. More specifically, the present disclosure relates to a computer implemented system and method for conducting trade of commercial vehicles at a dealership via an online trading website.

2. Description of the Related Art

Vehicle dealerships for commercial trucks are specifically designed to make the commercial truck trading process as simple and easy as possible. Such vehicle dealerships maintain the truck chassis information in a conventional database system, sometimes called a Dealer Management System. Potential work truck buyers may contact the dealerships either online or in person and request information specific to their needs and the type of work truck they are interested in purchasing. The buyers often like to search or browse for a specific chassis type, body, equipment, or any combination thereof. However, existing database systems are not capable of providing buyers with truck body information and how it relates to available chassis/body combinations. Moreover, the problem exists in automotive industry because of the relationship and flow of information across a supply chain necessary in building and selling a commercial work truck. Most of the information is available in multiple places and requires input from multiple people. Therefore, excessive time is required to gather information and requires a highly trained organized individual. The fractured gathered information cannot provide a clear picture of vehicles to initiate an effective commercial truck trading.

Conventional truck trading systems have considerable drawbacks. For example, the truck sale process is usually handled by any salesperson inside a dealership. The salesperson, while knowledgeable and skilled in selling trucks or chassis, oftentimes lacks the knowledge and skills necessary to deliver the right chassis/body combination. Sales that involve determining a chassis/body combination for a customer are usually more complicated than an ordinary truck or car sales and therefore most dealers generally prefer this to be handled by a specialized and more experienced salesperson. Unfortunately, this is not the case in many of the inquiries that occur inside the dealership on a daily basis. Often, the majority of calls and inquiries to a dealership are initially routed through a receptionist, Internet center or business development center (BDC) and are dispersed on first available salesperson basis. A buyer who needs a chassis/body combination work truck may desire to see what is available at the dealership, while the dealership may have a similar motivation to sell a work truck. Realistically, when the dealership does not have the requested truck in its physical inventory, the salesperson may attempt to persuade the buyer to purchase one of the trucks readily available regardless of the specifications or needs of the buyer and their intended use for the truck.

Other times, the salesperson may have the potential buyer work with a sales specialist if an appropriate truck is not on his lot, but may be available at other dealerships in the area. The sales specialist may negotiate with both the buyer and the other dealership in the area that has the specific work truck (chassis/body combination) that the buyer is looking for. In some other cases, the buyer inquiry is not handled in a timely manner with accurate information and leaves the customer unsatisfied, who may then resort to going to another dealership or perhaps a competing brand. In any of the situations above, and under the current system, it is only by luck that a customer receives the perfect combination of knowledge and experience resulting in the purchase of the requested truck at the right price and right time.

As another existing system to handle the problems described above, one system employs a specialized and more experienced salesperson to handle the trade of work trucks. For instance, the Ford Motor Company dealerships that participate in the selling and stocking of commercial work trucks have an individual with the title, Commercial Account Manager or CAM. The CAM obtains the customer inquiry via email or phone and starts the discovery process. Once armed with correct specifications and needs of the buyer, the CAM starts the search by entering the Ford chassis locator, which is a web based software application developed by Ford, to track and locate all new chassis manufactured by Ford and that are currently available in the buyer's market. The CAM uses the locator system, specifies the criteria of his customer and locates several chassis that appear to meet the criteria. The CAM finally contacts the location that has the work truck via conventional methods such as telephone or digital message (email, text, etc.). After the CAM locates a chassis that will work with the right body, they must determine if that chassis has a body, and what the body is. Although the CAM can manually enter desired body information into the chassis locator, this is a manual process and is rarely done. Thus, finding the right chassis and right body is a process that may take multiple calls, significant time on hold, and may still not result in finding the correct truck for the customer. Even if the correct truck is found, the customer may no longer be available. If the CAM cannot locate the requested truck before the customer has left, the customer may find a different brand of chassis with the requested body on it. The major drawback to this system and any others that may be in use by other vehicle manufacturers is that their system only identifies chassis, the body of the vehicle can only be added to their database if a manual entry is made for each individual body.

There are several other manual systems developed to meet the truck requirements of the buyer. Such systems gather information from multiple places and require manual input from multiple individuals. A major drawback associated with these systems is that there is no recorded data readily available to track, search or review regarding the finished truck. Thus, the commercial truck buyers are sometimes forced to buy the wrong truck due to lack of time and lack of choice. The current market and dealer culture along with normal consumer behavior fuels this process.

Therefore, there is a need for a simple, novel and online system to provide an improved means for conducting trade of commercial vehicles at a dealership. Such a system would provide an improved means of servicing an inquiry of a buyer at the dealership level. Such a system would include both on the ground and virtual inventory of vocation specific trucks with custom library of body types and pictures that quickly searches and returns the number of trucks or chassis/body combinations available. Such a system would allow the buyer to access simple and detailed specifications of all chassis and body types. This needed system would allow the buyers to view costs and shipping times, eliminating the need for additional emails and phone calls. Further, such a system would include a garage that allows buyers to make detailed and specific selections, compare products, and save them for further referencing and design. This system would provide a single source format to the buyer, a dealer, a body manufacturer or distributor, wherein the format would quickly provide accurate information on all inventory available. The system would provide transparent linking to all dealers' websites in such a way that the actual and virtual inventory is readily available at any dealer location. The system would include an easy to use interface for all dealership personnel to access and share with the buyer at a point of contact. Further, the system would provide instant notification to the buyer and the qualified sales personnel via text, SMS, cell phone, voice message and/or email for quick follow up. In addition, the system would notify qualified sales personnel when the system has been accessed. Such a system would be simple, efficient, and easy-to-use. Finally, this system would also provide an efficient means for the qualified sales personnel to conduct trade by protecting information pertaining to the costs and details necessary to make a solid quote to the buyer with all applicable rebates and incentives. This unique system overcomes prior art shortcomings by accomplishing these critical objectives.

### SUMMARY OF THE DISCLOSURE

In a preferred embodiment, a system and method for conducting trade of commercial vehicles at a dealership via an online trading website representing an online system and the related method for conducting trade between at least one buyer and a plurality of dealerships, and between the dealership and a body manufacturer or distributor.

The present invention comprises an online trading website managed by a commercial vehicle manager at the dealership and a vehicle database built into the online trading website configured to store actual and virtual inventory data of the commercial vehicles. The at least one buyer can contact the dealership to communicate requirements related to the commercial vehicles either online or in person. The vehicle database includes the virtual inventory data of the commercial vehicles, which consists of vehicle body data and vehicle chassis data. The vehicle body data is collected by means of invoices sent from the body manufacturer or distributor to the dealership. Invoices are received automatically via email, and ultimately will be generated through an intrinsic ordering system. The vehicle chassis data is maintained in Dealer Management Systems of all dealerships and may be extracted by a third-party service provider, or imported directly into the vehicle database. The third-party service provider processes the vehicle chassis data into a consistent data stream and transfers the consistent data stream into the vehicle database. The vehicle body data of each vehicle is systematically matched with either existing chassis that has been upfitted (or attached to) with that body or the vehicle chassis data of the chassis onto which the body can be physically mounted. For every combination of vehicle body and chassis, data on whether the combination is physically possible or not is maintained. The plurality of vehicle body/chassis combinations is stored in the vehicle database. The system can select a list of the plurality of vehicle body/chassis combinations offered for sale with other dealerships. The vehicle database is presented to at least one buyer via the online trading system. The at least one buyer accesses and searches the online trading system for a vehicle. A search result including the list of the plurality of vehicle body/chassis combinations is displayed in the online trading system. The at least one buyer selects appropriate body/chassis combination from the search result and the trade with the at least one buyer is closed by the dealership. The vehicle database is configured in such a way that the dealership and the at least one buyer can easily search or browse the online trading website for specific chassis type, body, equipment, or any combination thereof.

It is thus an object of the present invention to provide an online trading system that allows the dealership, the at least one buyer, the body manufacturer or distributor to access information of the commercial vehicles.

It is a further object of the present invention to provide a simple, efficient and easy-to-use system that allows the dealership to conduct trade in a simple and efficient manner.

It is a further object of the present invention to provide an improved means for servicing the requirements of the at least one buyer at the dealership level.

It is a further object of the present invention to provide a vehicle database that allows the at least one buyer to access simple and detailed specifications of vocation specific vehicle body and chassis types.

It is a further object of the present invention to provide a system that allows the body manufacturer or distributor to communicate with dealerships and other body manufacturers or distributors via an online trading website.

It is a further object of the present invention to provide a system that allows the body manufacturer or distributor to communicate with dealerships and other body manufacturers or distributors via an online trading website.

Yet another objective of the present invention is to provide a system that provides an easy to use interface for all dealership personnel to access and share with the at least one buyer at a point of contact.

These and other advantages and features of the present invention are described with specificity so as to make the present invention understandable to one of ordinary skill in the art.

### BRIEF DESCRIPTION OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention, thus the drawings are generalized in form in the interest of clarity and conciseness.

FIG. 1 is a schematic diagram of an online trading system for conducting trade of commercial vehicles at a dealership in accordance with the present invention;

FIG. 2 is a diagram illustrating an exemplary computer environment on which the online trading system may be implemented;

FIG. 3 is an operational flow chart of a method for conducting trade of commercial vehicles at the dealership via the online trading system in accordance with the present invention;

FIG. 4 illustrates a screenshot of an online trading website of the online trading system for conducting trade of commercial vehicles at the dealership in accordance with the present invention; and

FIG. 5 illustrates an exemplary workflow for onboarding the dealership of the online trading system in accordance with the present invention.

### DETAILED DESCRIPTION OF THE DRAWINGS

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

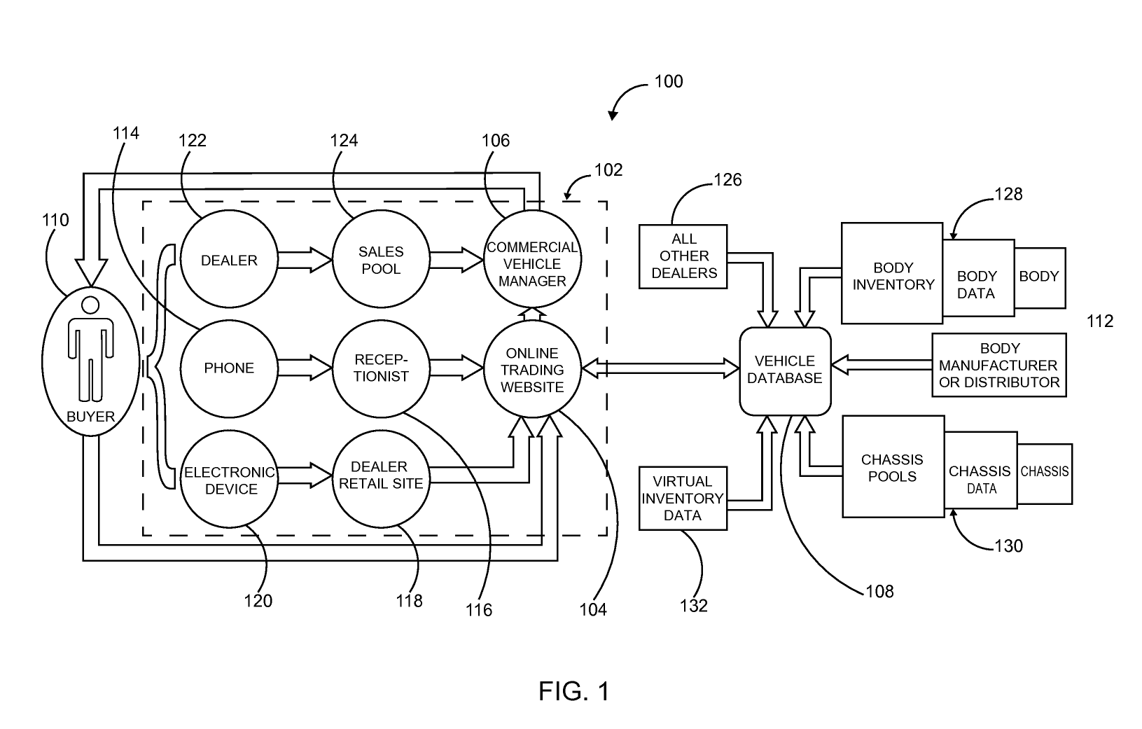

Turning first to FIG. 1, a schematic diagram of an online trading system 100 for conducting trade of commercial vehicles (also described as “work trucks”) at a dealership 102 in accordance with the present invention is illustrated. The online trading system 100 comprises an online trading website 104 managed by a commercial vehicle manager 106 at the dealership 102 and a vehicle database 108 built into the online trading website 104 configured to store virtual inventory data 132 of commercial vehicles. At least one buyer 110 can contact the dealership 102 to communicate requirements related to the commercial vehicles either online or in person. The at least one buyer 110 can either contact the dealership 102 by making calls and inquiries via phone 114 through a receptionist 116, wherein the receptionist 116 may search the online trading website 104 to find a desired commercial vehicle that meets the requirements of the at least one buyer 110. Through other means, the at least one buyer 110 may directly access a dealer retail website 118 via at least one electronic device 120. The at least one buyer 110 may then access the online trading website 104 from the dealer retail website 118. The at least one electronic device 120 may be selected from a group consisting of: a cellular telephone, a smartphone, a wireless-enabled personal digital assistant, a tablet, iPhones, a personal computer, a notebook, a mobile device and any other device that receives and transmits data. The at least one buyer 110 will then be redirected to the online trading website 104, where the at least one buyer 110 can search for the desired commercial vehicle meeting the specific requirements of the at least one buyer 110. The at least one buyer 110 may also directly contact a dealer 122 in person and request additional information specific to their needs and the type of vehicle interested in purchasing. The dealer 122 may then redirect the at least one buyer 110 to a sales pool 124 wherein the trade will be handled by the commercial vehicle manager 106, who is preferably an experienced and specialized salesperson. The at least one buyer 110 optionally can access directly the online trading website 104 via the at least one electronic device 120.

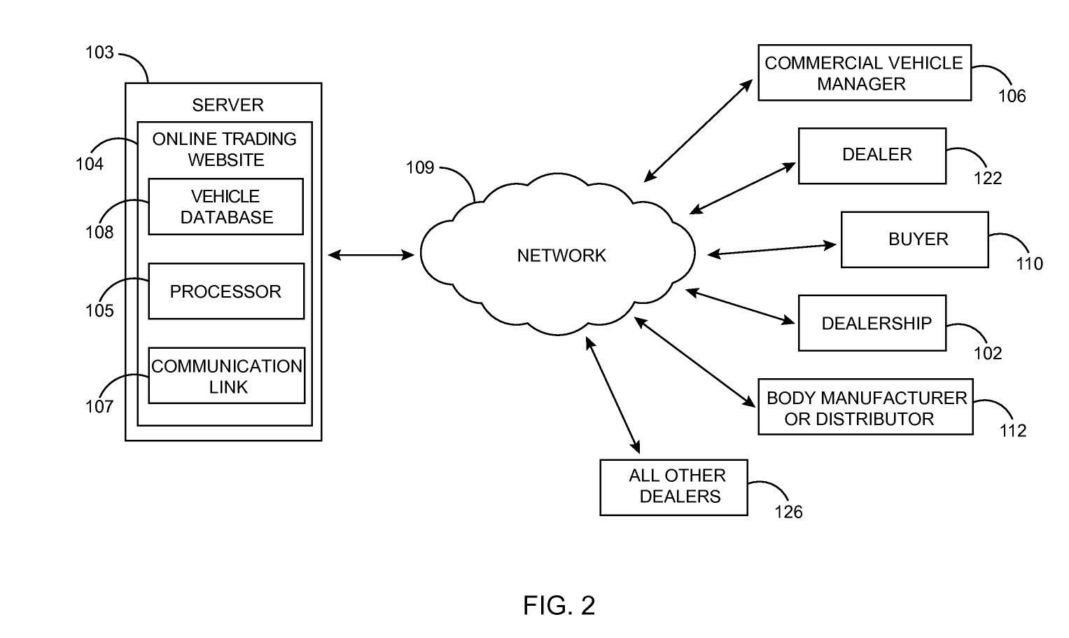

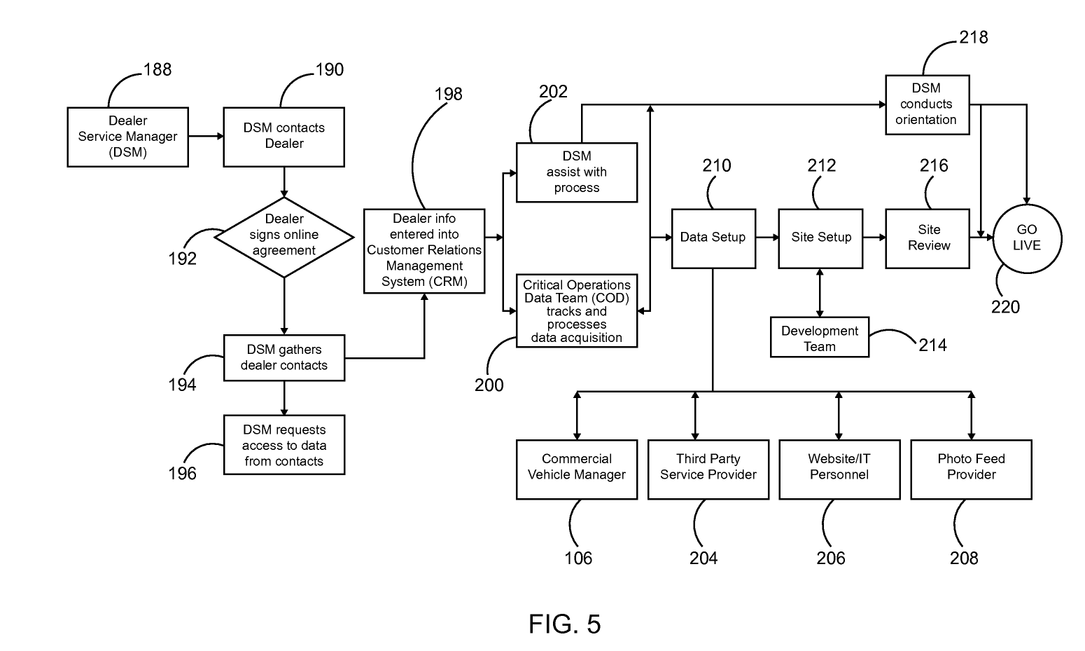

The vehicle database 108 includes the virtual inventory data 132 of the commercial vehicles, wherein the virtual inventory data 132 consists of a vehicle body data 128 and a vehicle chassis data 130. The vehicle body data 128 is collected by means of invoices sent from a body manufacturer or distributor 112 to the dealership 102 approved by the commercial vehicle manager 106. The vehicle chassis data 130 includes vehicle identification numbers (VIN) and engineering specifications, and is maintained in Dealer Management Systems of all dealerships and is extracted by a third-party service provider 204 (See FIG. 5). The third-party service provider 204 (See FIG. 5) may process the vehicle chassis data 130 into a consistent data stream and transfer this consistent data stream into the vehicle database 108. The commercial vehicle manager 106 has access to up-to-date inventory information in the form of invoices as well as stock numbers assigned by the dealership 102 and VIN. The vehicle body data 128 of each vehicle is systematically matched with the vehicle chassis data 130 of a chassis onto which a body can be physically mounted. The vehicle database 108 is configured in such a way that the dealership 102 and the at least one buyer 110 can easily search or browse the online trading website 104 for a specific chassis type, body, equipment, or any combination thereof. The dealer 122 may manually create a buyer account for the at least one buyer 110 to form a dealer-buyer database which allows the dealer 122 to manage all customers, such as contact points, contact lists, history of interaction with the at least one buyer 110 etc. by asking for the basic info of the at least one buyer 110. For instance, the dealer 122 can take basic info of the at least one buyer 110 through the phone and create account for the at least one buyer 110. Optionally, the system 100 may also be able to be integrated into existing dealer-buyer database systems. The commercial vehicle manager 106 can modify and/or add information such as most recent photographs and special remarks in the vehicle database 108 so that the at least one buyer 110 can see not only the factory specifications of the chassis and the body but also the actual condition of the entire vehicle and the equipment. The system 100 also allows the body manufacturer or distributor 112 to communicate via a network 109 (See FIG. 2) with all other dealers 126 and other body manufacturers or distributors by sending specific messages and questions regarding offers, products and availability. The body manufacturer or distributor 112 can also receive orders from dealers 122, send orders to the other body manufacturers or distributors, send and receive confirmation and update delivery times. The dealer 122 can contact the body manufacturer or distributor 112 or chassis manufacturer to place orders, review confirmation of the order and find estimated delivery time for the order via the network 109 (See FIG. 2). The body manufacturer or distributor 112 can use the network 109 to communicate with the dealers 122 and the other body manufacturers or distributors by sending specific or general messages about products and offers. The body manufacturer or distributor 112 can also utilize the network 109 (See FIG. 2) to receive orders from the dealers 122 and the other body manufacturers or distributors, send them confirmation and update delivery times. The online trading system 100 thus allows the dealership 102, the at least one buyer 110, and the body manufacturer or distributor 112 to access information of commercial vehicles via the network (See FIG. 2) so as to conduct trade in a simple and efficient manner.

The virtual inventory data 132 of commercial vehicles, including both the vehicle chassis data 130 and the vehicle body data 128, at multiple dealerships are maintained on the vehicle database 108 that provides each participating dealership 102 with the online trading website 104 to access and/or manage the vehicle database 108. The commercial vehicle manager 106 at each dealership 102 selects, using the online trading website 104, the commercial vehicles that may be offered for trade with other dealerships that meet certain criteria, such as geographic location. When the at least one buyer 110 accesses the dealer retail site 118 and searches for a vehicle, not only the commercial vehicles at the dealership 102 but also the commercial vehicles in other participating dealerships' inventory will show up as a result, as long as they are made available for trade. This allows the dealership 102 to selectively share its inventory with other dealers 126 for the purpose of instantly capturing the at least one buyer 110 who seeks a vehicle in their inventory but may be in a distant area. In turn, those other participating dealerships are able to present to the at least one buyer 110 a wider selection of vehicle body/chassis combinations that may be purchased either from them or through them via trading, thereby virtually extending their inventory. Many of these combinations may not physically exist either in the virtual inventory data 132 or on inventory the list of the other dealers 126. These virtual combinations are presented to the at least one buyer 110 who visit the online trading website 104, where they are shown as available options that take a longer delivery time than the vehicles in the virtual inventory data 132. Using the system 100, the search functionality and the virtual combinations, the at least one buyer 110 will be able to see the approximate length of time for delivering the vehicle. For virtual combinations, delivery time is a calculation that takes into account the physical distance of the chassis and body, as well as the time required to mount the body onto the chassis.

The body manufacturer or distributor 112 can look to increase/decrease inventory based on demand of the at least one buyer 110 by location. The system 100 can save virtual vehicle search information and what the at least one buyer 110 are viewing and saving so as to have a better idea of the demand of certain combinations. Information about the demand can be passed along to the OEM chassis manufacturers, body-manufacturer or distributor 112 so that they can easily predict future requests, demand, and sales. The dealer 122 can use this to increase or decrease inventory based on the type of demand of the at least one buyer 110. The system 100 may be able to send reports to the dealer 122 with this information. The system 100 may also comprise educational content that allows the at least one buyer 110 to educate themselves on the available body manufacturer or distributor 112 and their various body models.

FIG. 2 is a diagram illustrating an exemplary computer environment on which the online trading system 100 may be implemented. The online trading website 104 of the online trading system 100 hosted on a server 103. The online trading website 104 comprises a plurality of web pages that can be hosted on the server 103 and accessed over the network 109 by way of a locator address, such as a URL or URI. The server 103 includes or is in communication with the vehicle database 108, a central processing unit (“CPU”), or processor 105 and a communications link 107 to the network 109. The online trading website 104 managed by the commercial vehicle manager 106 is accessible over the network 109 to the at least one buyer 110, the dealership 102, the dealer 122, the body manufacturer or distributor 112 and all other dealers 126. The vehicle database 108 maintained in the online trading website 104 stores the virtual inventory data 132 of the commercial vehicles. The processor 105 of the online trading website 104 can be configured to access the virtual inventory data 132 in the vehicle database 108 in response to inputs by the commercial vehicle manager 106, the at least one buyer 110, the dealership 102, the dealer 122, the body manufacturer or distributor 112 and all other dealers 126, and as well as to commands from the online trading website 104. The network 109 is selected from a group consisting of: Internet, a local area network (LAN), a wide area network (WAN), wired Ethernet, wireless Ethernet, cellular wireless network and any other network capable of transmitting information. The vehicle database 108 is a conventional type and is used to store data about specific vehicles, vehicle body/chassis combinations, vehicle/pricing, transaction and other information as will be understood to those skilled in the art. While the vehicle database 108 is shown for convenience and ease of understanding as part of the server 103, it should be recognized that the vehicle database 108 could be a separate stand-alone system such as those provided by SAP, Oracle or other database companies and which communicates with the server 103.

For instance, the at least one buyer 110 who has to purchase a commercial vehicle accesses the online trading website 104 through the at least one electronic device 120. After entering the URL of the online trading website 104 into a web browser program of the at least one electronic device 120, a communications link is established between the at least one electronic device 120 of the at least one buyer 110 (the “client”) and the online trading website server (the “server”) 103. The at least one electronic device 120 of the at least one buyer 110 may access the online trading website 104 over any wired or wireless network now known or later developed, for example via a WAN, LAN, MAN, Bluetooth, Ethernet, Wi-Fi, satellite, GSM or PCS. The online trading website 104 may optionally be hosted on a plurality of servers.

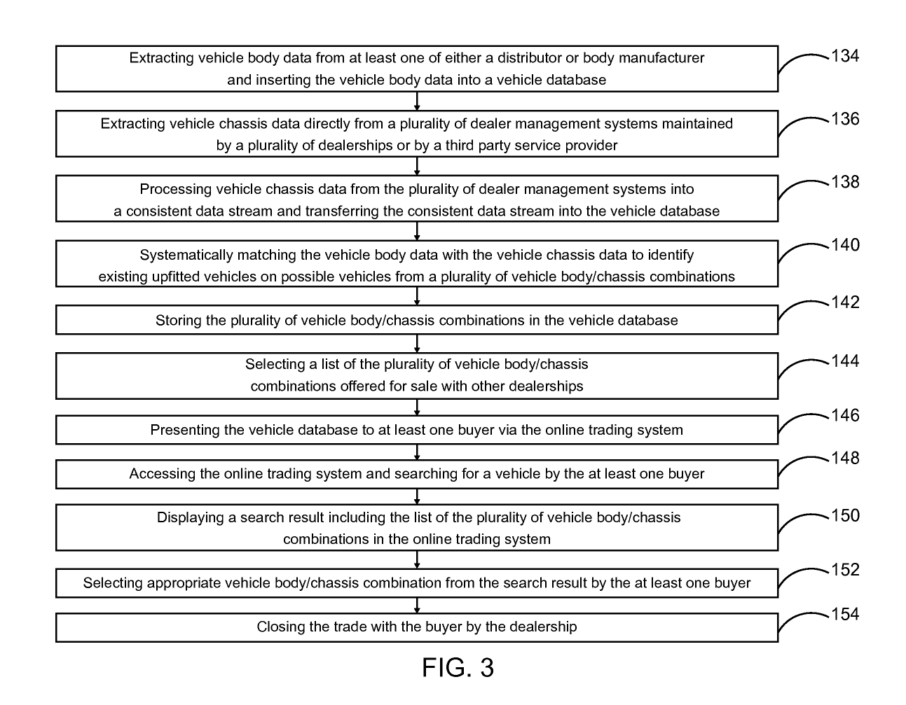

FIG. 3 is an operational flow chart of a method for conducting trading of commercial vehicles at the dealership via the online trading system in accordance with the present invention. Initially, vehicle body data is extracted from a distributor or body manufacturer and inserted into a vehicle database as shown in block 134. Next, vehicle chassis data is extracted from a plurality of Dealer Management Systems maintained by a plurality of dealerships or by a third party service provider as indicated at block 136. Then, the vehicle chassis data from the plurality of Dealer Management Systems is processed into a consistent data stream and transferred the consistent data stream into the vehicle database as shown in block 138. The vehicle body data is systematically matched with the vehicle chassis data to identify existing upfitted vehicles on possible vehicles from a plurality of body/chassis combinations as indicated at block 140. The plurality of vehicle body/chassis combinations is stored in the vehicle database as shown in block 142. In the next step, a list of the plurality of vehicle body/chassis combinations offered for sale with other dealerships is selected as indicated at block 144. Then, as shown in block 146, the vehicle database is presented to at least one buyer via the online trading system. The online trading system is accessed and searched for a vehicle by the at least one buyer as indicated at block 148. In the next step, a search result including the list of the plurality of vehicle body/chassis combinations is displayed in the online trading system as shown in block 150. Finally, as indicated at block 152, the appropriate body/chassis combination is selected from the search result by the at least one buyer and trade with the buyer is closed by the dealership as shown in block 154.

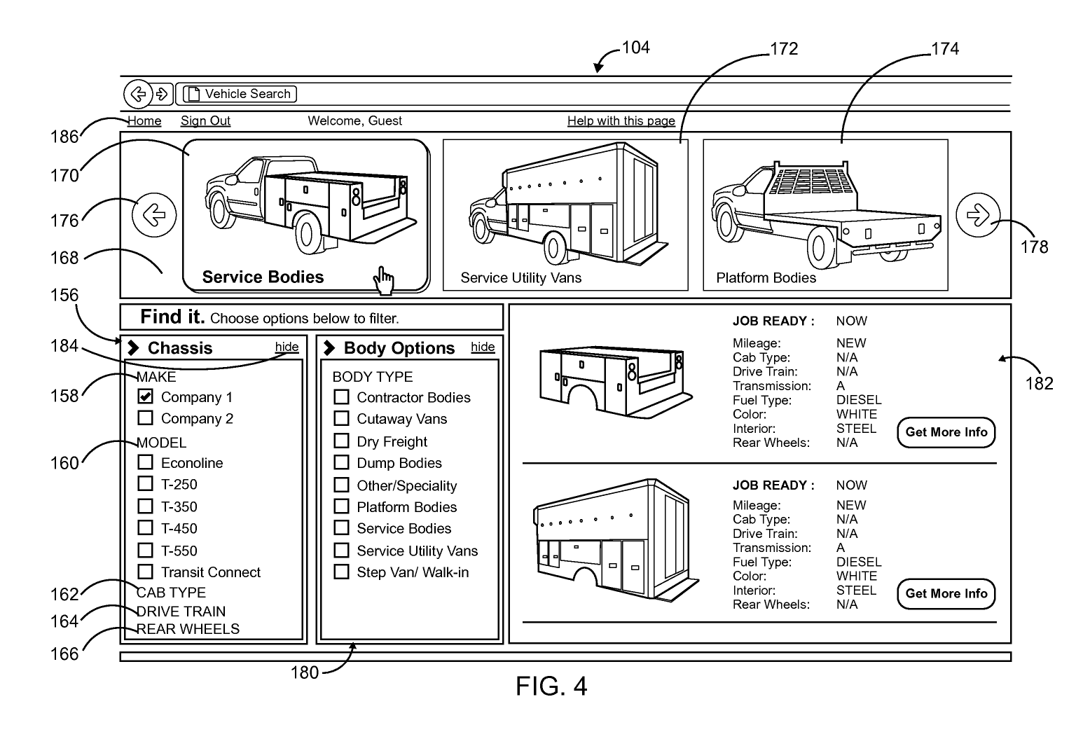

Referring to FIG. 4, a screenshot of an exemplary online trading website 104 of the online trading system 100 for conducting trade of commercial vehicles at the dealership 102 in accordance with the present invention is illustrated. The at least one buyer 110 can login to the online trading website 104 to view the virtual inventory data 132 of the commercial vehicles, which as described above includes the vehicle chassis data 130 and the vehicle body data 128. Although Ford chassis are shown here for purposes of understanding, the system is operable with all manufactures of trucks, such as GM, Chrysler, Toyota etc. A Chassis tab 156 allows the at least one buyer 110 to select the required chassis from a list of the vehicle chassis data 130. The Chassis tab 156 includes a Make tab 158, a Model tab 160, a Cab Type tab 162, a Drive Train tab 164 and a Rear Wheels tab 166. By clicking on the Make tab 158, the at least one buyer 110 can select the chassis manufactured by either Company 1 or Company 2 as desired. The Make tab 158 may further be modified to include other companies in the online trading website 104 by the commercial vehicle manager 106. The Model tab 160 allows the at least one buyer 110 to view various models of chassis. By clicking on the Cab type tab 162, the at least one buyer 110 can view three types of cabs such as Crew, Regular and Super. The Drive Train tab 164 and the Rear Wheels tab 166 displays the types of drive trains and types of rear wheels available, such as dual and single. The online trading website 104 also includes a scroll space 168 that includes various types of vehicle bodies such as Service Bodies 170, Service Utility vans 172, Platform Bodies 174 etc. The at least one buyer 110 may scroll left and right to view other vehicle body categories by clicking on the left arrow tab 176 and the right arrow tab 178 respectively. By clicking on any of the vehicle body types on the scroll space 168, the at least one buyer 110 will be presented with a Body Options tab 180. For instance, the at least one buyer 110 may select the Service bodies 170 from the scroll space 168, and in return the system 100 will display to the at least one buyer 110 a list of service body types. The Chassis tab 156 and the Body Options tab 180 allows the at least one buyer 110 to view the vehicle body/chassis combinations available in the dealership 102. This is initiated by clicking at least one Company in the Make tab 158 and at least one body type in the Body Options tab 180. The at least one buyer 110 will then be presented with a list of the vehicle body data 128 and chassis combinations 182 in the online trading website 104. Optionally, the system 100 may provide additional vehicle options such as vehicle accessories including but not limited to items such as power equipment like cruise control, power windows, push button four-wheel drive, etc. Still other options may include vehicle attributes such as axle ratio, transmission type, truck bed size, trailer hitch kit type, backup alarm etc. Still other options available may be what are generally considered accessories, such as ladders, roof racks, snowplows etc.

In certain instances, only the chassis of the vehicle may be shown and the vehicle body data 128 will not be displayed to the at least one buyer 110. For instance, if a vehicle does not have a custom body, the online trading website 104 may display a picture of the chassis in the area where a body model image would normally display. In addition, the online trading website 104 may display a vocational list of body choices for the at least one buyer 110 to select which would then provide additional filtering and searching in the vehicle database 108. Optionally, when the at least one buyer 110 is searching for a certain vehicle body/chassis combination, the underlying body information may not be shown. For example, to view the vehicle body model (example Ford F-650), the at least one buyer 110 may optionally have a certain type of user account. If the at least one buyer 110 does not have the user account, access to the vehicle body data 128 will not be allowed. The at least one buyer 110 can hide the Chassis tab 156 and the Body Options tab 180 by clicking on a hide tab 184. By clicking on a home page tab 186, the at least one buyer 110 will be redirected to the dealer retail site 118. The online trading website 104 may optionally include an available vehicle combinations list which includes a list of all possible combinations of vehicle by using the virtual inventory data 132 about all available chassis types and combining this with available body models that fit each chassis. Throughout all embodiments of the invention, the system 100 may optionally be able to avoid displaying any duplicate vehicles.

The online trading website 104 further includes a Buyer Search option, which allows the at least one buyer 110 to view all possible combinations of commercial vehicles, regardless as to if one is available on a dealer lot or not. The at least one buyer 110 may look through all available chassis near him and all available bodies near him, and the at least one buyer 110 can then assemble a “dream vehicle” based on all the components available. The at least one buyer 110 may optionally save a vehicle to the local dealer's website 118, regardless as to where the vehicle is actually located. This allows the at least one buyer 110 to work directly with their local dealer for purchasing and future service regardless of where the vehicle originated. Preferably, when the at least one buyer 110 searches for inventory on the online trading website 104, the virtual inventory data 132 will be listed first in the search results followed by the virtual vehicle body/chassis combinations of the dealer 122. Next, inventory of nearby dealers may optionally be displayed using a “Dealer Trade” option. The dealer 122 also has the capability to feature certain vehicles at the top of search results. Further, the dealers 122 can feature special offers to the at least one buyer 110 such as credit towards options, bodies or financing, and these special offers can only show vehicles from the other dealers 126 that the dealer 122 approves of, and the system 100 will offer a way for the dealer 122 to select a set of approved dealers.

The at least one buyer 110 should also be notified if a specific vehicle body/chassis combination becomes available using the “Dealer Trade” option. The “Dealer trade” is an option wherein the dealer 122 is able to offer additional vehicles to the at least one buyer 110 by showing inventory of nearby dealers as available to the at least one buyer 110. For instance, if the dealer 122 does not have the vehicle required by the at least one buyer 110, but has data about the vehicle being available from a nearby dealer and knows that nearby dealer would be willing to trade the vehicle, then the dealer 122 can show the at least one buyer 110 that the vehicle is available with the dealer 122. If the at least one buyer 110 wants to purchase the vehicle, the dealer 122 will first obtain the vehicle from the nearby dealer using “Dealer Trade” option. The dealer 122 can exclude vehicle as available for “Dealer Trade” within a certain mile radius and can also indicate the vehicles that are available for trade individually. The system 100 allows the dealer 122 to automatically schedule the vehicles available for trade based upon the number of days it has been in inventory, thus limiting the dealer's exposure to pay interest on flooring and other carrying costs for having a vehicle in the inventory for too long. In addition, the system 100 also provides an option to show “Dealer Trade” inventory on their website with the intention that anonymous buyers can view this inventory. This allows some dealers who do not want inventory only for “dealer trade” to be available to be seen by the anonymous buyers. The other dealers 126 who want this information to be seen may enable it to be viewed by the at least one buyer 110. Optionally, for vehicles that are only available for “dealer trade”, actual photos of these vehicles will not be used and only generic photographs of stock images may be used to represent the chassis and body model. The system 100 also displays vehicle location and dealer phone number when the dealer 122 is logged in and looking at the details for a “Dealer Trade” vehicle. The system 100 also handles transferring of VIN between the dealer 122 and the nearby dealers for the “Dealer Trade”. This normally involves the reporting of the transfer to a relevant government agency.

The online trading website 104 includes a Dealer-dashboard that provides a quick glance of what is happening with their account/dealership such as user activity reports, vehicle reports on a number of vehicles, sold vehicles etc. to the dealer 122. The online trading website 104 further includes a Dealer Search option that allows the dealer 122 to view specific chassis/body combinations that are otherwise not available to the dealer 122. The dealer 122 may search through this exclusive data to build a chassis/body combination for the at least one buyer 110 using a Dealer Inventory search option in which the dealer 122 has access to the relevant information needed in order to do this. The system 100 will have all the data on where chassis are located and body location, as well as what optional chassis and body types may be produced by the body manufacturer or distributor 112. Hence, if for instance one type of body is requested by the at least one buyer 110 of the dealer 122, the dealer 122 will be able to use the system 100 to determine which the body manufacturer or distributor 112 can make that body. Contact information for the body manufacturer or distributor 112 may be provided so that the dealer 122 can build the customized vehicle for the at least one buyer 110. In addition, the dealer 122 can use the online trading website 104 to determine status of vehicle, such as “ordered”, “sent to the body manufacturer or distributor 112”, or “in transit”. This information may also be used by the dealer 122, chassis-builder and the body manufacturer or distributor 112 to assist with their business planning. The dealer 122 can decide to optionally hide the vehicle prices from the anonymous buyers. For instance, if the at least one buyer 110 searches the virtual inventory data 132 over the network 109 (See FIG. 2), the dealer 122 may wish to have certain vehicles not listed with the final price, but instead with a place holder such as “contact us for price.” This is because the dealer 122 may wish that the anonymous buyers contact the dealer 122 for the final price. This is especially useful when the search result includes the vehicle that falls under the “Dealer Trade” category, because the dealer 122 does not know the final price of the vehicle since the dealer 122 will first have to obtain the vehicle from another nearby dealer and there may be negotiations involved in that transfer.

The online trading website 104 also facilitates the trade of vehicles between multiple dealerships. In one instance, the multiple dealerships may share a common owner, in which case the online trading website 104 may grant access to that owner to view all inventory across all commonly owned dealerships. In other instances, the multiple dealerships may have independent or otherwise separate owners, in which case the separate owners may view one-another's inventory in order to facilitate trade among them.

Although the online trading website 104 is primarily described as accessible by the at least one buyer 110 and the dealer 122, the body-manufacturer or distributor 112 and chassis-builders may benefit from use of the site as well. For instance, data gathered from the system 100 regarding the types of vehicles desired by the at least one buyer 110 may help the body-manufacturer or distributor 112 and chassis-builder meet ever-changing demand. The online trading website 104 may also facilitate communication between the dealer 122, the body-manufacturer or distributor 112 and chassis-builders for tracking shipments, payments, orders etc.

FIG. 5 illustrates an exemplary workflow for onboarding the dealership 102 of the online trading system 100 in accordance with the present invention. The online trading website 104 for each dealer 122 is created with the help of an Dealer Service Manager (DSM) 188, a Customer Relations Management system (CRM) 198, a Critical Operations Data team (COD) 200, the commercial vehicle manager 106 and the third party service provider 204. Initially, the DSM 188 contacts the dealer 122 and notifies the dealer 122 of an online agreement as shown in block 190.

When the dealer 122 accepts the terms of the agreement, the dealer 122 signs the agreement online as indicated at block 192, and then the DSM 188 contacts the dealer 122 and gathers all contact and data information of the dealer 122 as shown in block 194. The DSM 188 also sends emails to request access to data gathered from contacts to all dealership personnel at this time as indicated at block 196. The DSM 188 then enters all collected data of the dealer 122 into the CRM system as shown in block 198. The DSM 188 then contacts the COD team as shown in block 200 and provides all dealer specific information gathered at the dealership 102. Both the DSM 188 and the COD team 200 communicate frequently and coordinate completion of all information of the dealer 122 with entry into the CRM system 198. The DSM 188 assists with process while communicating with the COD team 200 as shown in block 202. Both the DSM 188 and the COD team 200 coordinate all steps on information collection of the dealer 122. The COD team 200 starts collection of the data from the all contacts of the dealer 122 such as the commercial vehicle manager 106, the third party service provider 204, website/IT personnel 206 and photo feed provider 208. The COD team 200 collects data regarding vehicle chassis/body combinations from the commercial vehicle manager 106 and vehicle chassis data from the third party service provider 204 and enters the setup data into the CRM system 198 as indicated at block 210. For instance, one such third party service provider 204 may be Authenticom out of La Crosse, Wis. The third party service provider 204 gathers data from the inventory of the dealer 122, populates an FTP with this information and processes all collected data into a consistent data stream. The COD team 200 further contacts the website/IT personnel 206, who is a dealership person responsible for a dealership website, and coordinates communication with the DSM as shown in block 202. The COD team 200 further contacts the photo feed provider 208, who is a dealership person responsible for uploading photos of the commercial vehicles to list in the virtual inventory data 132 and coordinates communication with the DSM 202. The COD team 200 enters all relevant information on the CRM system 198 and stores it on the data setup 210. The site is setup with the gathered data maintained in the data setup as indicated at block 212 and notifies a development team of collected data as indicated at block 214. The COD team 200 enters the dealer specific information required to create their new site and notifies the development team as shown in block 214 of each COD-specific data available for dealer test-site preparation, including, but not limited to, SEO and Google Analytics setup. The development team 214 in turn notifies the COD team 200 about the reception of the data. Upon completion of all data entry of the COD team 200 and receiving confirmation from the development team 214, the COD team 200 notifies the DSM 202 that the dealer retail site 118 readiness testing is complete. The site review, indicated at block 216, is initiated by the COD team 200 and starts with dealer site pre-test checklist. This includes the verification and entry of the initial manual vehicle chassis/body invoices into the site. COD Team 200 concludes pre-test site readiness checklist and shares pre-test site checklist with DSM 202. The DSM 202 then checks dealer site readiness and makes notation in CRM 198 upon completion. The COD team 200 reviews all dealer retail site 118 readiness test discrepancies/challenges and notifies appropriate teams to further test and repair. When repair is complete, the COD team 200 indicates the CRM system 198 that the dealer retail site 118 is approved internally for dealer orientation and ‘Go Live’. DSM 188 takes the lead and coordinates the orientation schedule with the dealership 102. DSM 202 conducts orientation with the commercial vehicle manager 106 and confirms successful orientation with the dealership 102 and Regional Teams as indicated at block 218. The COD team 200 notifies the Website Host(s) via email, also copying key dealership personnel, to authorize cutover to the URL of the online trading website 104. Upon notification, the dealer website host(s) switches to the online trading website URL. When links are confirmed, the COD team 200 announces via the CRM system 198 that the dealer website is now live as indicated at block 220. The data of the dealership 102 in the website 104 is automatically updated as Dealer Inventory Information is updated.

The system 100 of the present invention is configured as updatable so that year-to-year changes by the body manufacturer or distributor 112 or chassis-builders can be taken into account. For instance, Ford produces a 2014 Ford F-650 and a 2015 Ford F-650 and eventually will produce a 2016 F-650. The new model generally brings about new features in the vehicle, and these features will be taken into account in the system 100. The system 100 automatically detects new vehicles so as to allow administrators to filter all vehicles in the system 100 based on the vehicles added that day or since a previous date or time of their choosing. The at least one buyer 110 may optionally use such a feature to view only new vehicles as well. The system 100 is also set up to support multiple regions and reports may be generated on the system 100 based on region. For instance, a region may be “Northwest” and comprise multiple U.S. states or may be on a state-by-state basis, country-by-country basis or another regional basis, such as neighborhoods in a city. The system 100 will also have the capability to decode VIN numbers using a third party decoding platform. This capability will likely only be given to administrators of the system 100, but may potentially be expanded to allow access to the dealer 122 and/or the at least one buyer 110.

In one embodiment, a non-transitory computer readable medium storing one or more computer programs including instructions that, when executed by an online trading system, cause the online trading system to perform a method for conducting trade at a dealership described in FIG. 3 is provided. The method comprises extracting vehicle body data from at least one of either a distributor or body manufacturer and then inserting the vehicle body data into a vehicle database, extracting vehicle chassis data directly from a plurality of dealer management systems maintained by a plurality of dealerships or by a third party service provider, processing vehicle chassis data from the plurality of dealer management systems into a consistent data stream and transferring the consistent data stream into the vehicle database, systematically matching the vehicle body data with the vehicle chassis data to identify existing upfitted vehicles on possible vehicles from a plurality of vehicle body/chassis combinations, storing the plurality of vehicle body/chassis combinations in the vehicle database, selecting a list of the plurality of vehicle body/chassis combinations offered for sale with other dealerships, presenting the vehicle database to at least one buyer via the online trading system, accessing the online trading system and searching for a vehicle by the at least one buyer, displaying a search result including the list of the plurality of vehicle body/chassis combinations in the online trading system, selecting appropriate vehicle body/chassis combination from the search result by the at least one buyer, and closing the trade with the buyer by the dealership.

The described methods represent one possible algorithm for programming a computer system to perform the described functions. The described methods and/or systems are not mental processes, In one embodiment, the described methods and/or systems are implemented in a server to collect the virtual inventory data 132 of the commercial vehicles. In another embodiment, the described methods and/or systems are implemented in a separate computer from the server, for example, as an adjacent service that functions on the server. In one embodiment, the online trading system 100 of FIG. 1 is implemented preferably as JavaScript that runs in a user's browser to collect and record the virtual inventory data 132.

While for purposes of simplicity of explanation, the illustrated methodologies in the figures are shown and described as a series of blocks. It is to be appreciated that the methodologies are not limited by the order of the blocks, as some blocks can occur in different orders and/or concurrently with other blocks from that shown and described. Moreover, fewer than all the illustrated blocks may be used to implement an example methodology. Blocks may be combined or separated into multiple components. Furthermore, additional and/or alternative methodologies can employ additional blocks that are not illustrated.

An embodiment of the present invention relates to a computer storage product with a computer-readable medium having computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs, DVDs and holographic devices; magneto-optical media; and hardware devices that are specially configured to store and execute program code such as application-specific integrated circuits (“ASICs”), programmable logic devices (“PLDs”) and ROM and RAM devices. Examples of computer code include machine code, such as produced by a compiler, and files containing higher-level code that are executed by a computer using an interpreter. For example, an embodiment of the invention may be implemented using Java, C++, or other object-oriented programming language and development tools. Another embodiment of the invention may be implemented in hardwired circuitry in place of or in combination with machine-executable software instructions.

In other words, the system may be implemented as program code embedded in a computer program product in the form of a machine-usable or computer readable storage medium that provides program code for use by or in connection with a machine, a computer or any instruction execution system. Moreover, the system may comprise one or more computer programs that are executed on top of the system software after being loaded from storage media into local memory.

It should also be understood that the logic code, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language and may comprise one or more modules that may be executed on one or more processors in distributed, non-distributed, single or multiprocessing environments.

Certain embodiments are disclosed with reference to flowchart illustrations or block diagrams of methods, apparatus (systems) and computer program products according to embodiments. It will be understood that each block of the flowchart illustrations or block diagrams, and combinations of blocks in the flowchart illustrations and/or block diagrams may be implemented by computer program instructions. These computer program instructions may be provided to a processor of a general purpose computer, a special purpose machinery, or other programmable data processing apparatus to produce a machine, such that the instructions, which execute via the processor of the computer or other programmable data processing apparatus, create means for implementing the functions or acts specified in the flowchart or block diagram block or blocks.

These computer program instructions may also be stored in a computer readable storage medium that may direct a computer, other programmable data processing apparatus, or other devices to function in a particular manner, such that the instructions stored in the computer readable storage medium produce an article of manufacture including instructions which implement the function or act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer or machine implemented process such that the instructions which execute on the computer or other programmable apparatus provide processes for implementing the functions or acts specified in the flowchart or block diagram block or blocks.

The flowcharts and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical functions. It should also be noted that in some alternative implementations, the functions noted in the block may occur in any order or out of the order noted in the figures.

The foregoing description of the preferred embodiment of the present invention has been presented for the purpose of illustration and description. It is not intended to be exhaustive or to limit the invention to the precise form disclosed. Many modifications and variations are possible in light of the above teachings. It is intended that the scope of the present invention not be limited by this detailed description, but by the claims and the equivalents to the claims appended hereto.

What is claimed is:

1. An online trading system for conducting trade of commercial vehicles at a dealership, the system comprising:
an online trading website hosted on a server and managed by a commercial vehicle manager at the dealership; and
a vehicle database built into the online trading website, the vehicle database configured to store virtual inventory data of the commercial vehicles, the virtual inventory data comprising a vehicle body data and a vehicle chassis data;
whereby the vehicle database allows the dealership, at least one dealer, at least one buyer, at least one body manufacturer, and at least one distributor to access information of commercial vehicles via a network so as to conduct trade in a simple and efficient manner.

2. The online trading system of claim 1 wherein the vehicle database is configured in such a way that the dealership and the at least one buyer can easily search the online trading website for specific chassis type, body, equipment, or any combination thereof.

3. The online trading system of claim 1 wherein the virtual inventory data of the commercial vehicles is received from the at least one dealer and at least one of either a distributor or body manufacturer.

4. The online trading system of claim 1 wherein the vehicle body data is collected by means of invoices sent from the at least one of either a distributor or body manufacturer.

5. The online trading system of claim 1 wherein the vehicle chassis data includes vehicle identification numbers (VIN) and engineering specifications of the commercial vehicles.

6. The online trading system of claim 1 wherein the vehicle chassis data received from the Dealer Management System is processed into a consistent data stream and transferring the consistent data stream into the vehicle database by the third party service provider.

7. The online trading system of claim 1 wherein the vehicle body data is systematically matched with the vehicle chassis data to identify existing upfitted vehicles.

8. The online trading system of claim 1 wherein the commercial vehicle manager can modify and/or add information including photographs and special remarks in the vehicle database so that the at least one buyer can access both factory specifications of chassis and body and the actual condition of entire vehicle and equipment.

9. The online trading system of claim 1 wherein the commercial vehicle manager allows the at least one buyer to access and select the plurality of vehicle body/chassis combinations offered for a trade with other dealerships based on a geographic location.

10. The online trading system of claim 1 wherein the system allows the at least one distributor to receive orders from the at least one dealer, send orders to body manufacturers, send and receive confirmation and update delivery times via the network.

11. The online trading system of claim 1 wherein the system allows the body manufacturer to receive orders from dealers and distributors, send confirmation to the dealers and distributors and update delivery times via the network.

12. The online trading system of claim 1 wherein the system provide a dashboard for dealers on the online trading website to access the details of account/dealership including user activity reports, vehicle reports on number of the commercial vehicles and sold commercial vehicles.

13. The online trading system of claim 1 wherein the system provides a dealer trade option that facilitates the at least one dealer to offer additional vehicles to the at least one buyer by showing inventory of nearby dealers as available to the at least one buyer.

14. The online trading system of claim 13 wherein the system allows the at least one dealer to automatically schedule the commercial vehicles available for trade based upon the number of days the commercial vehicles listed in the inventory thereby limit the exposure of the at least one dealer to pay interest on flooring or even finally to purchase the commercial vehicles.

15. A method for conducting trade of commercial vehicles at a dealership via an online trading system, the method comprising:
(a) extracting vehicle body data from at least one of either a distributor or body manufacturer and then inserting the vehicle body data into a vehicle database;
(b) extracting vehicle chassis data directly from a plurality of dealer management systems maintained by a plurality of dealerships or by a third party service provider;
(c) processing vehicle chassis data from the plurality of dealer management systems into a consistent data stream and transferring the consistent data stream into the vehicle database;
(e) systematically matching the vehicle body data with the vehicle chassis data to identify existing upfitted vehicles on possible vehicles from a plurality of vehicle body/chassis combinations;
(f) storing the plurality of vehicle body/chassis combinations in the vehicle database;
(g) selecting a list of the plurality of vehicle body/chassis combinations offered for sale with other dealerships;
(h) presenting the vehicle database to at least one buyer via the online trading system;
(i) accessing the online trading system and searching for a vehicle by the at least one buyer;
(j) displaying a search result including the list of the plurality of vehicle body/chassis combinations in the online trading system;
(k) selecting appropriate vehicle body/chassis combination from the search result by the at least one buyer; and
(l) closing the trade with the buyer by the dealership.

16. The method of claim 15 wherein the at least one buyer can access the online trading system via an online trading website utilizing at least one electronic device.

17. The method of claim 15 wherein the vehicle database is configured in such a way that the dealership and the at least one buyer can easily search or browse the online trading website for specific chassis type, body, equipment, or any combination thereof.

18. A non-transitory computer readable medium storing one or more computer programs including instructions that, when executed by an online trading system, cause the online trading system to perform a method for conducting trade at a dealership, the method comprising:
(a) extracting vehicle body data from at least one of either a distributor or body manufacturer and then inserting the vehicle body data into a vehicle database;
(b) extracting vehicle chassis data directly from a plurality of dealer management systems maintained by a plurality of dealerships or by a third party service provider;
(c) processing vehicle chassis data from the plurality of dealer management systems into a consistent data stream and transferring the consistent data stream into the vehicle database;
(e) systematically matching the vehicle body data with the vehicle chassis data to identify existing upfitted vehicles on possible vehicles from a plurality of vehicle body/chassis combinations;
(f) storing the plurality of vehicle body/chassis combinations in the vehicle database;
(g) selecting a list of the plurality of vehicle body/chassis combinations offered for sale with other dealerships;
(h) presenting the vehicle database to at least one buyer via the online trading system;
(i) accessing the online trading system and searching for a vehicle by the at least one buyer;
(j) displaying a search result including the list of the plurality of vehicle body/chassis combinations in the online trading system;
(k) selecting appropriate vehicle body/chassis combination from the search result by the at least one buyer; and
(l) closing the trade with the buyer by the dealership.

19. The non-transitory computer readable medium of claim 18 wherein the at least one buyer can access the online trading system via an online trading website utilizing at least one electronic device.

20. The non-transitory computer readable medium of claim 19 wherein the vehicle database is configured in such a way that the dealership and the at least one buyer can easily search or browse the online trading website for specific chassis type, body, equipment, or any combination thereof.

21. The non-transitory computer readable medium of claim 19 wherein the vehicle body data is collected by means of invoices sent from at least one of either a distributor or body manufacturer.

22. The non-transitory computer readable medium of claim 19 wherein the vehicle chassis data includes vehicle identification numbers (VIN) and engineering specifications of the commercial vehicles.

23. The non-transitory computer readable medium of claim 19 wherein the vehicle chassis data and body data are analyzed and displayed as virtual inventory data.
